(19) United States
(12) Patent Application Publication
(10) Pub. No.: US 2012/0207954 A1
(43) Pub. Date: Aug. 16, 2012

(54) LAMINATE FOR PACKAGING HYGROSCOPIC MATERIALS, POUCHES MADE THEREFROM, AND METHOD FOR MANUFACTURING SAME

(75) Inventors: Jean-Francois DALPE, Laval (CA); Ian LLOYD-GEORGE, Laval (CA)

(73) Assignee: Hood Packaging Corporation, Burlington (CA)

(21) Appl. No.: 13/026,893

(22) Filed: Feb. 14, 2011

(51) Int. Cl. B32B 15/085; B29C 65/74; B29C 65/02; B32B 27/32; B32B 15/09

(52) U.S. Cl. 428/35.4; 428/344; 156/309.6; 156/227

(57) ABSTRACT

The present invention provides a novel packaging laminate designed particularly for packaging highly hygroscopic, pelleted, flowable materials. It is a multilayer structure which incorporates a layer of heat-sealable polymeric material which has had a thin film of aluminum deposited onto it by vapour coating. This layer combined with a further effective barrier layer provides the low WVTR in the range required by such highly hygroscopic materials. This laminate can be used with additional structural layers of paper or plastic, to form bags that have the features of very low WVTR, excellent puncture resistance, and excellent heat sealability.

### FIELD OF THE INVENTION

The present invention relates to a laminate with a very low rate of water vapour transmission, which is particularly suitable for packaging flowable hygroscopic solids in pelleted form.

### BACKGROUND OF THE INVENTION

Most dry packaged goods are vulnerable to environmental moisture. In humid environments, moisture absorbed by the product through its packaging can have a number of undesirable effects on the shelf life and usefulness of the contents, depending on the packaged product. For instance, crystalline or powder substances can absorb moisture and become clumped. Biologically active chemicals can become hydrolyzed following water absorption. Absorbed water will hasten the spoilage of many dry food materials. Such materials which have the characteristic of tending to absorb moisture from the air are termed “hygroscopic”.

To combat this problem, there have been many developments in packaging materials in order to produce low Moisture or Water Vapour Transmission Rates (commonly abbreviated to “MVTR” or “WVTR”) through the packaging. Depending on the value of the packaged contents and the extent to which it is crucial to minimize WVTR, the amount invested in engineering for the packaging and the quantity of materials used to construct it will vary. For instance, dry food stuffs such as flour and sugar are moisture sensitive but they are also inexpensive and are typically sold at a high rate of turnover, and therefore do not require very long periods of storage. Limited moisture entering the package does not generally cause significant problems for the contained product. These materials are often simply packaged in multi layers of coated kraft paper which are relatively inexpensive and deemed to provide sufficient protection. A WVTR in the range of 6.0 g of water per 100 square inches of packaging material per 24 hours, at the standard testing conditions of 90% relative humidity, 38 degrees Celcius, is considered commercially acceptable for these types of products.

Items such as solid pet food pellets are somewhat more sensitive to moisture entry, as moisture tends to increase the rate of spoilage of such protein and fat containing products. Further, if the pet food clumps, it decreases the flowability of the product, which is problematic for the consumer. Manufacturers therefore tend to utilize a packaging material with lower rates of WVTR, in the range of 0.4-0.8 g/100 square inches per 24 hours in standard testing conditions. Such packaging is often comprised of polyethylene laminated to kraft paper, or all-plastic laminates, as such materials are relatively inexpensive and are found to have sufficiently low WVTR.

The overall goal in terms of packaging hygroscopic materials is to make a packaging that provides adequate product protection, and at the same time is economically viable to produce.

Some hygroscopic materials are very sensitive to humidity, are also sufficiently expensive, and may require storage for longer periods of time before use, in order to justify investment in a packaging treatment that greatly minimizes WVTR. The resin pellets used in the manufacture of materials such as laminates or plastic containers or bags, such as pellets of nylon or ethylene vinyl alcohol, are available from a number of chemical suppliers including DUPONT™, BASF™, and HONEYWELL™. Such materials are provided as granular pellets as this is the format that is most convenient to work with in terms of laminate manufacturing.

Such pellets are highly hygroscopic. They have a very low tolerance to environmental humidity, requiring WVTR in the range of 0.05-0.08 grams of water per 100 square inches per 24 hours under standard testing conditions. Moisture causes the pellets to rapidly degrade, and given their expense and often long periods of storage, this would present a significant economic problem for the many industrial consumers of such products. Moisture further causes the pellets to clump, which reduces the ability of the user to pour the pellets into vehicles such as hoppers during the manufacturing process, to accurately pour specific measured amounts, or to readily mix the pellets with other solid granular materials.

A known effective barrier material which imparts the feature of low WVTR to packaging is metal foil, most commonly aluminum foil. Foil is typically used as a protective layer when packaging resin pellets. However, foil can be relatively brittle and easily punctured or torn. Given that pelleted resins tend to be hard and may have sharp edges, additional measures have been necessary to make the package puncture-resistant. Such packages have therefore been further lined with a protective plastic layer in addition to the aluminum foil.

A further practical requirement for packaging such industrial grade products is good sealability. The packaging will typically be made into large pouches or bags which may contain anywhere from twenty to forty kilograms of pellets. Such pouches must be able to withstand rough handling conditions during transport and shipping, vibrations and bouncing during travel, as well as being dropped from moderate heights during delivery without breakage or bursting at the seams of the pouch.

Given the above requirements, the type of package used in the industry for packaging hygroscopic resin pellets has been thick, heavy, and expensive to manufacture. The typical prior art package has included a layer of aluminum foil as well as a further protective polymer layer on the package interior in order to shield the aluminum foil from contact with the resin pellets. The aluminum foil has further been attached to several layers of heavy gauge kraft paper. This combination provides the low WVTR necessary for such product, but is both bulky and expensive to manufacture. The packaging is relatively thick, in the range of 9-10 mils. Given rising fuel costs resulting in increased shipping expenses for heavier goods, and the scarcity of resources needed to manufacture such bulky packaging, it would be advantageous to have a thinner, lighter material that is less expensive to manufacture but which has the required low WVTR, puncture resistance, and sealability.

### SUMMARY OF THE INVENTION

The present invention provides a packaging laminate designed particularly for packaging highly hygroscopic, pelleted, flowable materials. Described herein is a multilayer laminate which incorporates a layer of polymeric material which has had a thin film of metal deposited onto it by vapour coating. This layer combined with a further effective moisture barrier layer provides the low WVTR in the range required by such highly hygroscopic materials. This laminate can be used with or without additional structural layers of paper or plastic, to form bags that have the features of very low WVTR, excellent puncture resistance, and excellent heat sealability.

In one embodiment the invention relates to a packaging material incorporating a heat sealable layer of oriented polypropylene or polyethylene terephthalate upon which has been deposited a thin coating of aluminum. This metallized layer is further adhered to a multilayer laminate which is comprised of linear low and/or high density polyethylenes. This combined structure can then be adhered or laminated to one or more plies of paper or heavy plastic, both of which function to provide structure and strength to the laminate. This packaging material has the required very low level of WVTR, and is also particularly strong and puncture resistant. The oriented polypropylene layer further shows excellent heat sealing characteristics.

The present invention is also directed to a method of manufacturing the laminate of the invention. A layer of polymeric material is provided with a heat sealable surface on one side, and a metallized surface on the other. A multilayer laminate is separately prepared by blown tube co-extrusion. The multilayer laminate is then adhered to the metallized side of the oriented polypropylene, and the entire resulting structure may then optionally be adhered to a ply of structural material such as kraft paper or a relatively thick structural plastic sheet having a gauge in the range of 5 mil. Further plies of structural material may also be added. The resulting multilayer structure forms a packaging material that can then be used to make bags that are particularly suitable for packaging pelleted hygroscopic materials.

In a further aspect, the present invention is directed to a bag formed of the laminate of the present invention for packaging pelleted hygroscopic materials.

In a still further aspect, the present invention is also directed to a method of forming the bag made from the laminate of the present invention.

### BRIEF DESCRIPTION OF THE FIGURES

The present invention will now be better understood with reference to the detailed description and tables and to the accompanying figures in which:

FIG. 1 is a drawing of a pouch that can be constructed using the laminate of the invention; and

FIG. 2 is a graph demonstrating the heat sealability of the test packaging as compared to a traditional foil laminate.

### DETAILED DESCRIPTION OF THE INVENTION

The present invention provides a novel packaging laminate designed particularly for packaging highly hygroscopic, pelleted, flowable materials. It is a multilayer structure which incorporates a layer of a polymeric material which has had a thin film of aluminum deposited onto it by vapour coating. This layer combined with a further effective moisture barrier layer provides the low WVTR in the range required by such highly hygroscopic materials.

In one embodiment, the present invention provides a multi-layer laminate having a core layer comprising a first outer layer comprised of linear low density polyethylene, low density polyethylene, and anti-block agent; an inner layer comprised of linear low density polyethylene, low density polyethylene, and slip additive; and a second outer layer comprised of linear low density polyethylene, low density polyethylene, and anti-block agent. The multi-layer laminate includes a metallized layer of polymeric material having a heat sealable surface and a metallized surface wherein the metallized surface is adhered to the second outer layer and optionally a structural layer selected from a paper or a plastic that is adhered to the first outer layer. The multi-layer laminate has a water vapour transmission rate of less than 0.05 g/100 square inches/24 hours measured at 38 degrees Celcius and 90% relative humidity. In an alternative embodiment the water vapour transmission rate is less than 0.005 g/100 square inches/24 hours measured at 38 degrees Celcius and 90% relative humidity.

In one embodiment, the multi-layer laminate has an average energy to break of at least 8.0 pounds per inch. In another embodiment the multi-layer laminate has an average energy to break of at least 9.0 pounds per inch.

In one embodiment, the multi-layer laminate has an average puncture of at least 3.0 feet per pounds force per inches cubed. In another embodiment, the multi-layer laminate has an average puncture of at least 4.0 feet per pounds force per inches cubed.

Tables 1 and 2 show sample formulations of the multi-layer laminate described herein. As set out therein, there are essentially three components to the multi-layer laminate of the invention: A. a metallized layer such as a metallized biaxially oriented polypropylene which will face the interior of any bag made using the laminate of the invention; B. a three-layer core laminate with barrier properties, and C. one to three outer structural layers of kraft paper which will be located to the exterior of any bag made using the laminate of the invention.

In terms of the metallized layer, as set out in both sample formulations, a biaxially oriented polypropylene was chosen as the base for this layer. Polypropylene is a material with good heat sealing characteristics, and the process of aligning it in two directions (i.e. biaxial orientation) is known to improve the strength of the film, the modulus (resistance to stretching) and also to improve the moisture barrier properties of the film because of the increased crystallinity of the polymers, all of which are features imparted by the orientation process.

An alternate embodiment for the metallized layer could comprise polyethylene terephthalate film, which may be engineered to have good moisture barrier properties, and which may be coated on one side with a metal coating. A heat sealable layer could then be formed on or adhered to the opposite side of the film.

In terms of the three-layer core laminate, the ingredients of sample formulations are provided in tables 1 and 2 respectively. In one embodiment, the multi-layer laminate includes a core comprising a middle and two outer layers formed of quantities of linear low density polyethylene and low density polyethylene. Also included in the formulations are additives typically used in the film manufacturing process. Antiblock additives are included in order to minimize adhesion between adjacent sheets of film. Polymer processing aids were added in order to enhance the extrusion abilities of the film being made. Slip additives are added in order to reduce the surface coefficient of friction of the laminates being formed. Each of these types of additives are available from a number of chemical supply companies.

In one embodiment the three components of the core of the multi-layer laminate include outer layers comprising linear low density polyethylene. The multi-layer laminate core comprises first and second outer layers each comprising from about 88 to about 92% linear low density polyethylene, from about 6 to about 10% low density polyethylene, and from about 1 to about 2% antiblock agent; and an inner layer comprising from about 88 to about 92% linear low density polyethylene, from about 6 to about 10% low density polyethylene, and from about 1 to about 2% slip agent.

Set out in Table 1 is an example of the multi-layer laminate of this embodiment including a structural layer of kraft paper.

TABLE 1
LLDPE Formulation

| | | |
|---|---|---|
| | | Package Exterior Side |
| kraft Paper | | |
| | 1-3 plies | |
| Core Layer | | |
| | Layer A (25%): 90.50% linear low | |
| | density polyethylene | |
| | 8.00% low density polyethylene | |
| | 1.50% antiblock agent | |
| | Layer B (50%): 90.40% linear low | |
| | density polyethylene | |
| | 8.00% low density polyethylene | |
| | 1.60% slip agent | |
| | Layer C (25%): 90.50% linear low | |
| | density polyethylene | |
| | 8.00% low density polyethylene | |
| | 1.50% antiblock agent | |
| Metallized | | |
| layer | | |
| | Metallized biaxially oriented | |
| | polypropylene | |
| | | Package Interior Side |

In an alternative embodiment, the formulation for the three-layer core laminate comprises a middle layer formed from high density polyethylene, low density polyethylene, and very low density polyethylene. The two outer layers are identical in composition and are formed principally from linear low density polyethylene and low density polyethylene. Antiblock, polymer processing aids, and slip agents are also used in this formulation. In one embodiment the multi-layer laminate comprises first and second outer layers each comprising from about 77 to about 82% linear low density polyethylene, from about 15 to about 19% low density polyethylene, from about 2 to about 4% antiblock agent, from about 0.5 to about 1.5% polymer processing aid; and an inner layer comprising from about 70 to about 77% high density polyethylene, from about 13 to about 17% low density polyethylene, from about 8 to about 12% very low density polyethylene, and from about 0.5 to about 1.5% slip agent.

Set out in table 2 is an example of the multi-layer laminate of this embodiment including a structural layer of kraft paper.

TABLE 2
HDPE Formulation

| | | |
|---|---|---|
| | | Package Exterior Side |
| kraft Paper | | |
| | 1-3 plies | |
| Core Layer | | |
| | Layer A (25%): 79.00% linear low | |
| | density polyethylene | |
| | 17.00% low density polyethylene | |
| | 3.00% antiblock agent | |
| | 1.00% polymer processing aid | |
| | Layer B (50%): 73.90% high | |
| | density polyethylene | |
| | 15.00% low density polyethylene | |
| | 10.00% very low density | |
| | polyethylene | |
| | 1.10% slip agent | |
| | Layer C (25%): 79.00% linear low | |
| | density polyethylene | |
| | 17.00% low density polyethylene | |
| | 3.00% antiblock agent | |
| | 1.00% polymer processing aid | |
| Metallized | | |
| layer | | |
| | Metallized biaxially | |
| | oriented polypropylene | |
| | | Package Interior Side |

Following formation of the three-layer laminate, the next step in the manufacturing process is the adhesion of the three-layer laminate to the metallized layer, which can be accomplished by any known method.

The combined three layer barrier and the metallized biaxially oriented polypropylene can then be attached to a further structural layer such as kraft paper. Paper is a convenient material, particularly for the outermost layer, as it has a high coefficient of friction and therefore can be used to make packages with good stackability. Paper is also readily printed on. The combined laminate may be adhered to a single ply of paper, which may in turn be adhered to further plies of paper, prior to converting into bags or any other desired packaging structure.

Instead of paper, another possible embodiment is an all plastic bag in which the barrier films are laminated to structural plastic having a thickness in the range of 5 mil. In another embodiment the structural plastic layer is at least 4 mil thick. A material may be chosen for the outer plastic which provides a high coefficient of friction, and the plastic may be printable as well.

### Example

The following detailed example will make reference to Table 1 above. A three layer core laminate is formed in accordance with the recipe provided. Layer A contains 90.50% linear low density polyethylene (the SCLAIR™ brand purchased from NOVA™), 8.00% low density polyethylene (purchased from DOW™), and 1.50% antiblock agent. Layer A comprises 25% of the total mass of the three-layer laminate. Layer C is identical in composition and mass to layer A. Layer B contains 90.40% linear low density polyethylene (also the SCLAIR™ brand from NOVA™), 8.00% low density polyethylene (from DOW™), and 1.60% of a slip agent. Layer B comprises the remaining 50% of the mass of the three-layer laminate. The three layers A, B, and C are co-extruded by standard methods of blown tube co-extrusion. The three-layer core laminate is formed to have a thickness of 1.2 mil.

Following cooling and rolling, the three-layer laminate is then adhered to a metallized biaxially oriented polypropylene film with a vaporized aluminum deposit on one side, and a heat sealable surface on the other side. An appropriate product is available from Celplast Metallized Products Limited™ under the name FOILMET BOPP™, and was used successfully. This film is 0.70 mil thick, is metallized on one side, and is heat sealable on the other, and thus incorporates the necessary sealant layer. The heat sealable layer can be sealed to itself or to another surface using heated crimp sealer jaws or similar heat sealing apparatus.

A solventless adhesive, such as the aromatic polyurethane adhesive called DURO-FLEX™ 37-9451 available from NATIONAL STARCH™ is then applied, and the laminates are adhered together using a standard roll to roll laminator. The newly formed laminate is then cured for 24 hours.

The entire laminate is then adhered to one ply of paper using a standard adhesive applied in rows. Kraft Unbleached SPK paper available from TOLKO™ Marketing and Sales Ltd. has been successfully used. Further plies of outer paper may also be adhered using standard methods. When adhered to two additional plies of outer paper, the thickness of the material is between 6.5-7.0 mils. The material is then ready for conversion into bags.

Another aspect of the invention is a bag formed using the laminate of the invention, after it has been further adhered to additional plies of paper as described above. This provides a versatile packaging material in terms of the types of bags that may be formed from it, as the inside polypropylene layer may be sealed both to itself, and to an outer surface of the bag.

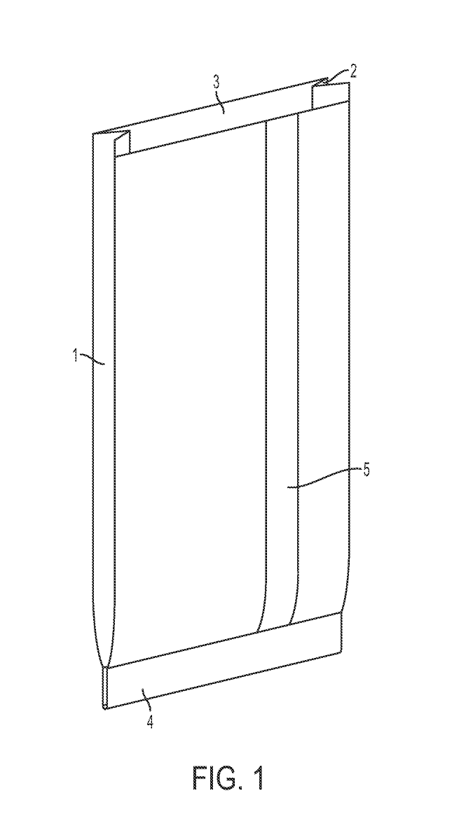

The structures of bags used for packaging are known in the art. A sample bag structure is shown in perspective view in FIG. 1. Following the appropriate cutting of the packaging material, the bag may be formed to have side gussets 1 and 2, a lap seal 5 along the bag's longitudinal axis formed by the application of heat, an open mouth 3 for later filling of the bag, and a closed pinch bottom 4 which is also sealed by heat.

The foregoing steps constitute the preferred method by which the laminate and bag of the present invention are made. However, it will be apparent to those of skill in the art that variations may be applied to the steps in the method without departing from the scope of the invention. All such similar substitutes and modifications apparent to those skilled in the art are deemed to be within the spirit, scope, and concept of the invention as defined by the claims.

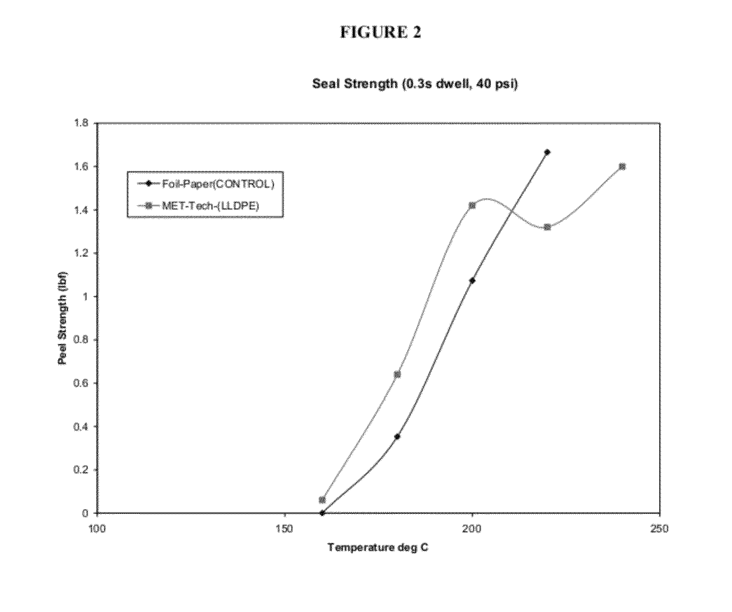

Laminates of this invention comprise an arrangement of polymeric layers and a metallized layer that each contribute both individually and collectively to improving moisture barrier properties, puncture resistance, and sealability, producing a unique set of beneficial properties. These properties are described in further detail with reference to tables 3-7 and FIG. 2.

Table 3 shows WVTR results using a standard testing method, ASTM E96-05, the “Standard Test Method for Water Vapor Transmission of Materials”. Three samples were tested: two laminates of the invention and a control. The two laminates of the invention were formulated in accordance with the specifications provided in tables 1 and 2 respectively (the LLDPE embodiment and the HDPE embodiment). A traditional foil/paper laminate was used as a control.

TABLE 3
WVTR Test Results using ASTM E96-05

| | WVTR |
|---|---|
| Sample | (g/100 square inches/24 hours) |
| Control: traditional foil laminate | 0.0129 |
| Test Laminate (LLDPE embodiment) | 0.00645 |
| Test Laminate (HDPE embodiment) | 0.0194 |

In accordance with ASTM E96-05, laminate samples of a standard size (0.0645 metres squared) were tested in conditions of 23+/−2 degrees Celcius, with 50+/−2% relative humidity. Specified volumes of water were placed into water-impermeable containers which were then sealed with laminates using a sealant comprised of 60% microcrystalline wax and 40% refined crystalline paraffin wax. The containers were then weighed before and after testing to determine the average mass loss which could be attributed to water exiting the container through the laminate. Testing took place over a 45 day period.

As set out in table 3, the LLDPE embodiment achieved a WVTR of 0.00645 g/100 inches²/24 hours. The control traditional foil laminate had a WVTR of 0.0129 g/100 inches²/24 hours. While the HDPE embodiment had a higher WVTR of 0.0194 g/100 inches²/24 hours, it is still a very low WVTR that renders the HDPE embodiment commercially acceptable for packaging highly hygroscopic materials.

Table 4 shows WVTR results using another standard testing method, ASTM F372, in which both the LLDPE and HDPE embodiments were tested against the traditional foil laminate as a control. The equipment used for this test was the MOCON PERMATRAN™ 3/60, with films being conditioned in the instrument for 24 hours prior to measurements being taken. The effective surface area of the samples tested was 10 square centimeters, and the carrier gas used was nitrogen. The temperature was 38 degrees Celcius with a humidity of 90+/−3%. As set out in FIG. 5, the LLDPE again performed better than the traditional foil control, achieving a WVTR of 0.0017 g/100 inches²/24 hours as compared to the 0.0018 g/100 inches²/24 hours measured for the traditional foil control. The HDPE embodiment was found to have a WVTR of 0.0019 g/100 inches²/24 hours, which is higher than the control or the LLDPE embodiment, but still well within the range required for packaging highly hygroscopic materials.

TABLE 4
WVTR Test Results using ASTM F372

| | WVTR |
|---|---|
| Sample | (g/100 square inches/24 hours) |
| Control: traditional foil laminate | 0.0018 |
| Test Laminate (LLDPE embodiment) | 0.0017 |
| Test Laminate (HDPE embodiment) | 0.0019 |

Results were confirmed for the LLDPE embodiment using a further test. Table 5 shows the test results for Water Vapour Transmission using ASTM D 3079-94, “Standard Test Method for Water Vapour Transmission of Flexible Heat-Sealed Packages for Dry Products”, also known in the industry as the “Jungle Room” test. This test is commonly used for assessing packaging materials to determine the amount of humidity that will reach the contents of the package. The test involves weighing empty packages, then filling them with a quantity of dessicant, such as calcium chloride. The packages are then sealed, and placed for predetermined times in environments of controlled temperature and humidity, at 37.8+/−1.1 degrees Celcius, and 90+/−2% relative humidity. The packages are weighed afterwards, the weight of the empty packages being subtracted from that of the dessicant-filled packages. The difference in weight will be the amount of water vapour that entered the package during the test.

TABLE 5
Jungle Room Test Results (ASTM D 3079-94)

| Sample | Water Weight Gain in 28 days |
|---|---|
| A: Test Invented Laminate | 19.78 g |
| B: Traditional Foil | 2.54 g |
| C: Kraft Standard Package | 207.71 g |

As detailed in table 5, three types of package materials were tested: A: the test laminate (LLDPE embodiment), B: a traditional foil laminate used as a control, and as a further comparative control, C: a standard laminate for packaging moderately moisture-sensitive materials. In this test, sample C was a multi-walled kraft bag lined with HDPE, which is used commercially to package dry pet food.

For each of the types of package materials A-C, samples were sealed empty or sealed with dessicant. All samples were placed in the conditioning chambers with temperature and humidity conditions as set out above. Following set periods, the packages were weighed inside the conditioning chamber to determine weight gain over the total test period, 28 days. Weight gain of the empty control samples was deemed to be water absorption of the paper exterior packaging. Weight gain of the dessicant-containing samples was deemed to be a function of both water absorption of the paper packaging, and water absorption of the contained dessicant material due to water vapour transmission through the test samples. The difference between the test samples and control samples was considered to reflect the extent to which packages A-C allowed the transmission of water to reach the package contents.

As seen in table 5, sample C which represents a standard package for moderately hygroscopic materials, allowed the passage of 207.71 grams of water into the package over the test period. Sample B, the traditional heavy foil laminate packaging (having layers of aluminum foil, polymer, and three plies of kraft paper) was much less permeable to water, allowing the passage of 2.54 grams of water. Sample A, the invented laminate (LLDPE embodiment), allowed the passage of 19.78 grams of water over the 28 day period, which provides results sufficiently close to the much heavier traditional laminate to be commercially viable for packaging such highly hygroscopic pellets. In other words, the Sample A results show that the invented laminate has low enough WVTR to be considered functionally comparable with the traditional heavy foil laminate package.

The results of the testing shown in tables 3, 4 and 5 reveal that the invented laminates have comparable WVTR to the traditional heavy foil laminate packaging (having layers of aluminum foil, polymer, and three plies of kraft paper). As the invented laminate is far less expensive to manufacture, and uses less material than the traditional foil laminate, yet has excellent WVTR in the range required, it may be concluded that the traditional foil laminate may be considered overengineered for the purpose it needs to fulfill.

The strength of the LLDPE embodiment of the invention was also assessed. Table 6 shows the results of standard puncture testing of the laminate. A traditional foil laminate was again used as a control, and tested against the LLDPE embodiment. For all test samples, the two outer plies of kraft paper were removed. All tests were therefore conducted on the laminate when adhered to only one outer layer of kraft paper.

TABLE 6
Puncture Test Data

| | Traditional Foil | |
|---|---|---|
| Test Parameter | Laminate Control | Test Laminate |
| Average Elongation | 0.42 inches | 0.68 inches |
| at Break | | |
| Average Energy | 4.7 lbs/inch | 9.5 lbs/inch |
| to Break | | |
| Average Puncture | 1.7 feet/lb force/inches³ | 4.1 feet/lb force/inches³ |
| Average Peak Load | 37.2 lb force | 40.2 lb force |

In the puncture testing method used, strips of laminate were clamped by their edges in a testing machine under controlled conditions of temperature and humidity. A probe was then used to penetrate the laminates at controlled speeds, until rupture occurred. Measurements were taken from which the puncture-resistance of the laminates could be assessed.

As set out in table 6, the first parameter measured for each of the samples was the Average Elongation at Break, which is the average amount of stretch in the laminate prior to breakage by the probe as described above. As shown, the LLDPE embodiment of the invention showed significantly higher elongation at break of 0.68 inches, as compared to 0.42 inches for the traditional foil laminate control. This shows that the LLDPE embodiment has greater resistance to puncture than the control.

The next parameter measured was the Average Energy to Break, which is the number of pounds of force per inch required for the probe to displace the laminate. The traditional foil laminate control required 4.7 pounds of force to displace the laminate by one inch. The LLDPE embodiment is much stronger, requiring 9.5 pounds of force. In this test, the LLDPE embodiment therefore tolerated more than double the force of the control. This result again shows the excellent puncture resistance of the LLDPE embodiment.

The next parameter measured was the “Average Puncture”, measured in feet per pounds of force per inches³. The Average Puncture of a given film is the energy needed per unit area to puncture the film, taking into account the contact surface area of the probe, and the thickness of the film. The traditional foil control required 1.7 feet/lb force/inches³ whereas the LLDPE embodiment required 4.1 feet/lb force/inches³, almost 2.5 times that amount.

The final parameter measured was the Average Peak Load, which is the averaged maximum pounds of force that was needed to break the film. The LLDPE embodiment again performed better than the traditional foil control in this regard, requiring 40.2 lb of force versus 37.2 lb of force for the control.

The results set out in table 6 demonstrate that the LLDPE embodiment of the invented laminate is stronger and more puncture-resistant than the currently used traditional foil laminate. This is a beneficial characteristic, particularly when the invented laminate is used to package heavy quantities of pelleted hygroscopic materials.

Finally, it is also functionally important that the laminate and packaging formed by it have good sealing characteristics so that a firm closure can be made of the package. There are many known ways of sealing a package, but the most convenient method is by applying heat through clamping jaws.

FIG. 2 displays the heat sealing profile of the package of the invention. In this graph, the invented package is termed “Met-tech (LLDPE)”, and was formulated using the specifications provided in table 1, with three plies of kraft paper. The LLDPE embodiment was compared to a traditional foil laminate package also incorporating three plies of kraft paper. The variable temperature applied to create the seal is set out on the X axis, and the peel strength required to separate the seals after a cooling period is set out on the Y axis. The seals were created using a dwell time of 0.3 seconds, and an applied pressure of 40 psi. These parameters are in the range typically used in commercial operations.

As shown by FIG. 2, the laminate of the invention displays superior sealing characteristics. While the seal initiation temperatures of the invented laminate and the control are the same at 160 degrees, even at that temperature the seal of the invented laminate is stronger than that of the control. This superiority in strength continues up to the point where the temperature reaches 200 degrees Celcius. This provides the invented laminate with a “sealing window” of 160 degrees to 200 degrees Celcius, over which strong seals can be demonstrated.

In commercial terms, bags formed of the laminate provided to customers for filling and sealing can therefore be used with a wider variety of heat sealing apparatus, which will work as long as their temperatures land within the sealing window. The seal initiation temperature of 160 degrees is relatively low for a laminate being sealed through several plies of paper. The low seal initiation temperature means that in commercial applications, less energy will be required to heat seal at this lower temperature, and the laminate is more tolerant to any inadequacies in the customer's heat sealing equipment. The contents of the package are also exposed to less heat during filling and sealing, which is a further beneficial feature of this invention.

Also provided herein is a method of producing a multi-layer film comprising the steps of forming a core layer of laminate, as described herein, adhering said core layer to a barrier layer of metallized polymeric material having a heat sealable surface and a metallized surface, wherein the metallized surface is adhered to the second outer layer and adhering the first outer layer of said core layer to a structural layer of material selected from a paper or a plastic. The method may further comprise adhering one or more additional plies of paper to the structural layer of paper.

Also provided is a moisture barrier bag comprising the laminate described herein which has been sealed to itself to form a bag. The bag may also include at least one lap seal, wherein a portion of the heat sealable surface is sealed to a portion of the structural layer selected from plastic or paper. The bag may also include at least one gusset seal.

Also provided is a method of forming a bag for containing hygroscopic materials, comprising the steps of providing a laminate, as defined herein, cutting the laminate to a size and shape suitable for forming a bag, folding the laminate to form a body having a front wall and a back wall, such that said heat sealable surface of said barrier layer of metallized polymeric material will form the inside surface of the bag and such that the opposing edges of said laminate will overlap. Further heat-sealing the overlapping edges of the laminate to form a lap closure along an axis of the bag and forming a closed bottom end on an axis perpendicular to the axis of the lap closure, by sealing the bottom end with heat or adhesive in order to prevent product from exiting the bag via the bottom end.

Also provided is a bag that is manufactured in accordance with the method described above.

Within the scope of the claims set out below, a person of skill in the art may make adjustments to the formulations and steps described above. Therefore, while the invention has been described with reference to specific embodiments thereof, it will be appreciated that numerous variations, modifications, and embodiments are possible, and are to be regarded as being within the spirit and scope of the invention.

What is claimed is the following:

1. A multi-layer laminate comprising:
a core layer comprising:
a first outer layer comprising linear low density polyethylene, low density polyethylene, and an anti-block agent;
an inner layer comprising linear low density polyethylene, low density polyethylene, and a slip agent;
a second outer layer comprising linear low density polyethylene, low density polyethylene, and an anti-block agent; and
a metallized layer of polymeric material having a heat sealable surface and a metallized surface wherein said metallized surface is adhered to said second outer layer;
wherein said multi-layer laminate having a water vapour transmission rate of less than 0.05 g/100 square inches/24 hours measured at 38 degrees Celcius and 90% relative humidity.

2. The multi-layer laminate of claim 1, further comprising at least one structural layer formed from paper or plastic that is adhered to said first outer layer.

3. The multi-layer laminate of claim, 1 wherein said multi-layer laminate has an average energy to break of at least 8.0 pounds per inch.

4. The multi-layer laminate of claim 1, wherein said multi-layer laminate has an average puncture of at least 3.0 feet per pounds force per inches cubed.

5. The multi-layer laminate of claim 1, wherein said polymeric material is selected from biaxially oriented polypropylene and polyethylene terephthalate.

6. The multi-layer laminate of claim 1, wherein
said first outer layer comprises about 25% by weight of said core layer;
said inner layer comprises about 50% by weight of said core layer, and
said second outer layer comprises about 25% by weight of said core layer.

7. The multi-layer laminate of claim 1 wherein
said first outer layer and said second outer layer each comprise from about 88 to about 92% linear low density polyethylene, from about 6 to about 10% low density polyethylene, and from about 1 to about 2% antiblock agent; and
said inner layer comprises from about 88 to about 92% linear low density polyethylene, from about 6 to about 10% low density polyethylene, and from about 1 to about 2% slip agent.

8. The multi-layer laminate of claim 1 wherein
said first outer layer and said second outer layer each comprise 90.5% linear low density polyethylene, 8.00% low density polyethylene, and 1.50% antiblock agent; and
said inner layer comprises 90.40% linear low density polyethylene, 8.00% low density polyethylene, and 1.60% slip agent.

9. A multi-layer laminate comprised of:
a core layer comprising:
a first outer layer comprised of linear low density polyethylene, low density polyethylene, anti-block agent, and polymer processing aid;
an inner layer comprised of high density polyethylene, low density polyethylene, very low density polyethylene, and slip agent;
a second outer layer comprised of linear low density polyethylene, low density polyethylene, anti-block agent, and polymer processing aid;
a metallized layer of polymeric material having a heat sealable surface and a metallized surface wherein said metallized surface is adhered to said second outer layer; and
said multi-layer laminate having a water vapour transmission rate of less than 0.05 g/100 square inches/24 hours measured at 38 degrees Celcius and 90% relative humidity.

10. The multi-layer laminate of claim 9, further comprising at least one structural layer formed from paper or plastic that is adhered to said first outer layer;

11. The multi-layer laminate of claim 9, wherein said multi-layer laminate has an average energy to break of at least 8.0 pounds per inch.

12. The multi-layer laminate of claim 9, wherein said multi-layer laminate has an average puncture of at least 3.0 feet per pounds force per inches cubed.

13. The multi-layer laminate of claim 9, wherein said polymeric material is selected from biaxially oriented polypropylene and polyethylene terephthalate.

14. The multi-layer laminate of claim 9, wherein
said first outer layer comprises about 25% by weight of said core layer;
said inner layer comprises about 50% by weight of said core layer, and
said second outer layer comprises about 25% by weight of said core layer.

15. The multi-layer laminate of claim 9 wherein
said first outer layer and said second outer layer each comprise from about 77 to about 82% linear low density polyethylene, from about 15 to about 19% low density polyethylene, from about 2 to about 4% antiblock agent, from about 0.5 to about 1.5% polymer processing aid; and
said inner layer comprises from about 70 to about 77% high density polyethylene, from about 13 to about 17% low density polyethylene, from about 8 to about 12% very low density polyethylene, and from about 0.5 to about 1.5% slip agent.

16. The multi-layer laminate of claim 9 wherein
said first outer layer and said second outer layer each comprise 79% linear low density polyethylene, 17% low density polyethylene, 3% antiblock agent, 1% polymer processing aid; and
said inner layer comprises 73.9% high density polyethylene, 15% low density polyethylene, 10% very low density polyethylene, and 1.1% slip agent.

17. A method of producing a multi-layer film comprising the steps of:
forming the core layer of claim 1;
adhering said core layer to a barrier layer of metallized polymeric material having a heat sealable surface and a metallized surface, wherein said metallized surface is adhered to said second outer layer; and
adhering said first outer layer of said core layer to a structural layer of material selected from a paper or a plastic.

18. A moisture barrier bag comprising the laminate of claim 1, which has been sealed to itself to form a bag.

19. A method of forming a bag for containing hygroscopic materials, comprising the steps of:
providing the laminate of claim 1;
cutting said laminate to a size and shape suitable for forming a bag;
folding said laminate to form a body having a front wall and a back wall, such that said heat sealable surface of said barrier layer of metallized polymeric material will form the inside surface of said bag and such that the opposing edges of said laminate will overlap;
heat-sealing the overlapping edges of said laminate to form a lap closure along an axis of said bag; and
forming a closed bottom end on an axis perpendicular to the axis of said lap closure, by sealing said bottom end with heat or adhesive in order to prevent product from exiting the bag via said bottom end.
